(19) United States
(12) Patent Application Publication
(10) Pub. No.: US 2012/0119487 A1
(43) Pub. Date: May 17, 2012

(54) PIPE CONNECTOR

(75) Inventors: Bjørn Pettersen, Holmestrand (NO); Birger Vaage, Heggedal (NO)

(73) Assignee: SEA DESIGN A/S, Drammen (NO)

(21) Appl. No.: 13/378,305

(22) PCT Filed: Jun. 15, 2010
(86) PCT No.: PCT/NO2010/000230

§ 371 Date: Feb. 2, 2012

(30) Foreign Application Priority Data
Jun. 15, 2009 (NO) 20092309

(51) Int. Cl. F16L 27/04; F16L 19/00; F16L 25/00

(52) U.S. Cl. 285/263; 285/330

(57) ABSTRACT

A connector for pipes which are used for transportation of powder, grain, gas and fluids is designed such that pipes with a moderate angular misalignment can be connected without bending of the pipes, and without loss of sealing capacity, and comprises a first hub (2) and a second hub (1), wherein the first hub (2) has an external thrust ring (6) with spherical inner and outer surfaces which is pressed and locked against the first hub (2) by a clamp 5 during connection.

### TECHNICAL FIELD OF THE INVENTION

The invention is a connector for pipes which are used for transportation of powder, grain, gas and fluids.

The connector is designed such that pipes with a moderate angular misalignment can be connected without bending of the pipes, and without loss of sealing capacity.

### BACKGROUND

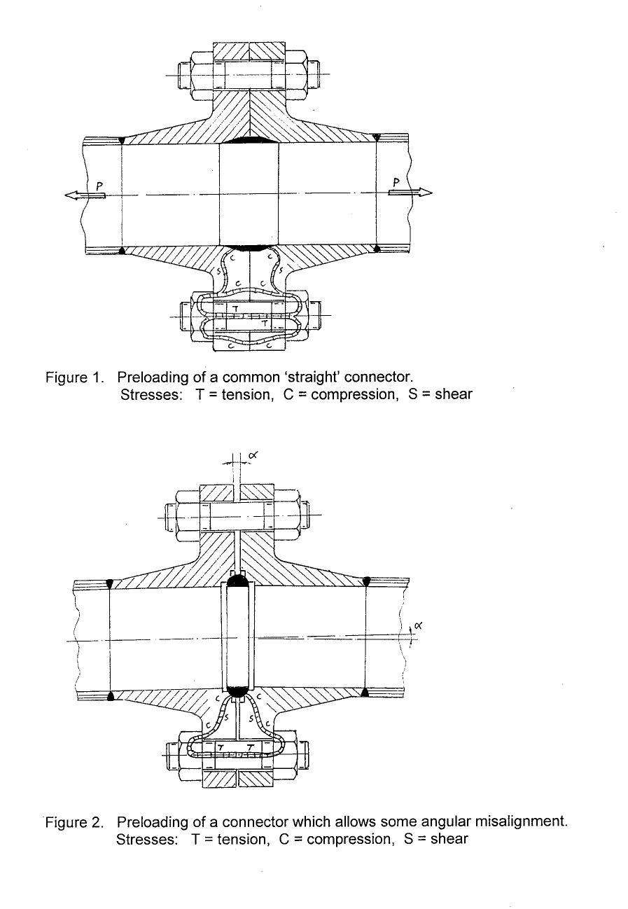

Pipe flanges are often misaligned before connection. Common practice is to pull the flanges together with axial force and application of bending moment, until the flanges become parallel. This is necessary to generate sufficient preload of the flanges. FIG. 1 shows the principle:

The flange bolts, or a clamp, press the flanges (or hubs) together and generate two load paths in the process:
a) A primary load path between the flanges around each bolt or clamp interface.
b) A secondary load path between the flanges and the seal ring The load paths are shown in FIG. 1 as ribbons.

An axial force (P) will first reduce the compressive stress between the flanges, since the primary load path is more rigid than the secondary load path. The flanges will remain in contact as long as the axial force is less than the preload between the flanges, and there will be no significant additional stretching of the bolts, and no significant increase of the bolt loads.

Additional axial load after the flanges have separated will act directly on the bolts. The bolts will stretch, the flanges will move apart, the seal will slip in its seats and leakage will begin. The flange preload is what secures the connection against leakage.

Preloading of misaligned flanges will normally result in bending of the pipes, and induce permanent bending stresses in the pipes. This may require stronger pipes to resist the internal pressure in the pipes.

There are other types of connectors where the flanges are not in contact with each other, or only partly in contact. The preload between the flanges acts instead through the seal ring. See FIG. 2.

The seal has a small contact area against the flanges, and it is made from a relatively soft material, compared with the flanges. The preload must be low to avoid damaging the seal.

These connectors can be made up with an angle (α) between the pipe centerlines.

A tensile axial force will act practically directly on the bolts. The bolts will stretch, the flanges will move apart, the seal will slip in its seats, and leakage will begin. These connectors are not suitable for high pressure pipes.

### DESCRIPTION OF THE INVENTION

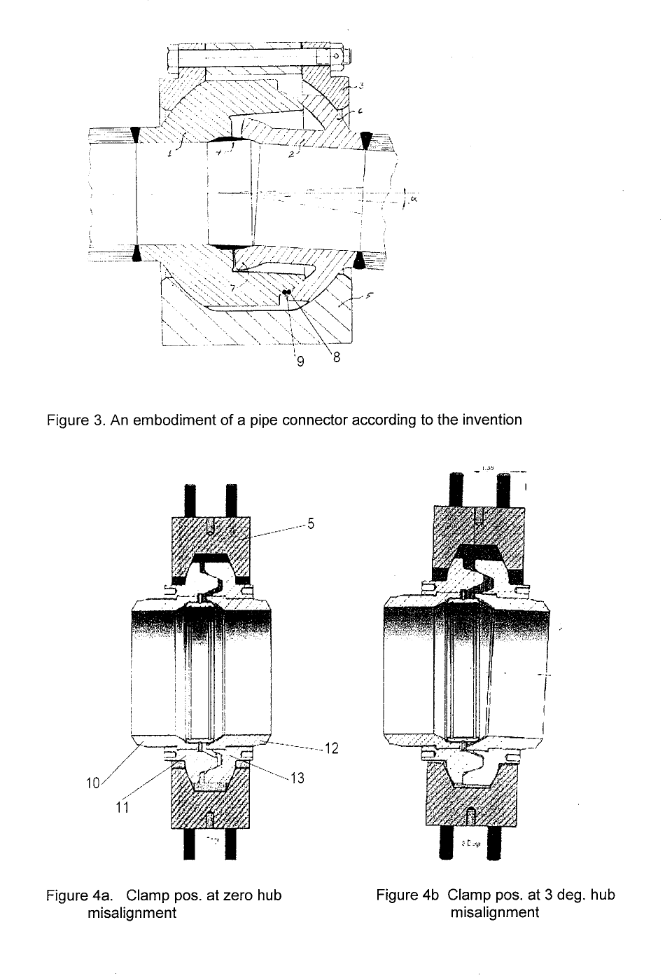

The present invention provides a pipe connector which avoids one or more of the above-mentioned drawbacks found with prior art connectors. The pipes can be connected without changing the angular misalignment. The connector is designed such that preload can still be achieved directly between the flanges, bypassing the seal. FIG. 3 shows a section through the invention.

It consists of the following parts:
1) Hub A
2) Hub B
3) Retainer (ring)
4) Seal ring
5) Bolts or segmented clamp
6) Thrust ring (A spherical flange on the hub B)
7) Nose (part of hub B)
8) Backup seal
9) Environmental seal

Hub B with the thrust ring has four spherical surfaces. The surfaces have their common center approximately at the center of the seal ring. The four spherical surfaces are located:
At the interface with the seal ring
At the interface with hub A (nose of hub B against inside of hub A)
At the interface with hub A (Thrust ring against hub A)
At the interface with the retainer.

The spherical surfaces at the interface of hub B and the seal ring shall provide sealing of the pipe. This shall also seal when hub B has an angular misalignment in relation to the seal ring.

The surfaces at the interface of hub B and the inside of hub A function as a guide for hub B during connection. It is also a suitable location for a back-up seal.

The spherical surfaces at the interface of the thrust ring and hub A shall primarily transfer axial force, and provide a load bypass of the seal ring. This also applies to the spherical surfaces at the interface between the thrust ring and the retainer.

Note that the thrust ring and its location is a major difference between this invention and other similar inventions.

Hub B may be fitted with a ‘nose’ (7) for guiding during connection. The nose slides against the inside of hub A, centering hub B in relation to hub A, before hub B comes in contact with the seal ring. This is to avoid damaging the seal ring. It is particularly important for large and heavy connectors. See FIG. 3.

The make-up sequence of the invention is as follows: (See FIG. 3)
The seal ring (4) is installed in hub A (1).
Hub B (2) is pushed against hub A.
Hub B is centered by hub A. (Nose (7) against inner diameter of hub A).
Hub B enters over the seal ring.
The segmented clamp (5) is mounted on the outside of the hubs. The retainer (3) is part of this clamp.
The clamp is tightened, and clamps the thrust ring between hub A and the retainer. The angular misalignment of hub B remains unchanged.

When the invention is loaded by a tensile axial force:
The tensile force follows this load path: Hub B-thrust ring-retainer-clamp-hub A. The tensile axial force bypasses the seal ring.
   When the invention is loaded by a compressive axial force:
The compressive force follows this load path: Hub B-thrust ring-hub A. The compressive axial force bypasses the seal ring.
   a) There may be a small clearance between the thrust ring and the retainer/hub A after connection, such that hub B can rotate about a transverse axis. This will allow the hub to adjust to pipe displacement after installation, without causing significant bending moment on the connection.
   b) A dynamic connector (flex joint) is a connector where the angle of rotation about a transverse axis varies repeatedly. The invention can be used as a flexible joint of a pipe, when clearance between the thrust ring and the retainer/hub A are combined with a suitable (dynamic) seal ring.
   c) Each hub may consist of two different pieces, see FIGS. 4a and 4b: An inner hub (10, 12) which interfaces with the seal, and an outer hub (11, 13) (or flange) which interfaces with the other outer hub (11, 13) and the retainer/clamp (3, 5). The outer hubs may be manufactured in a different material from the inner hubs, and be interference fit over the inner hubs. The purpose of this is to optimize the material characteristics of the various parts of the connector.
   d) The interface of the retainer/clamp (3, 5) with the hub and thrust ring may be non-spherical as shown in FIGS. 4a and 4b. The clamp will adapt different positions depending on the angular misalignment of the hubs. This arrangement allows use of a narrower clamp, and reduces the total width of the connector and provides a uniform load distribution.

1. A pipe connector, comprising:
a hub B (2); and
a hub A (1), wherein
hub B (2) has an external thrust ring (6) with spherical inner and outer surfaces, the thrust ring being pressed and locked against hub A (1) by a clamp (5) during connection, the spherical contact areas on the thrust ring allow the hubs to be connected even if there is an angular misalignment between the hubs.

2. The pipe connector according to claim 1, wherein a small clearance between the thrust ring and hub A or the retainer allows hub B to rotate about a transverse axis and adjust to pipe displacement after the connection is made up.

3. The pipe connector according to claim 2, wherein a seal ring (4) suitable for dynamic movement is used.

4. The pipe connector according to claim 3, wherein the connector is further provided with a back-up seal (8) for the seal ring (4).

5. The pipe connector according to claim 4, wherein the connector is further provided with additional environmental seals (9) to prevent intrusion of external medium into the connector.

6. The pipe connector according to claim 5, wherein hub A and hub B each comprise an inner hub (10, 12) weldable to the pipe, and an outer hub/flange (11, 13).

7. The pipe connector according to claim 6, wherein the inner hub (10, 12) and the outer hub/flange (11, 13) are constructed by different materials.

8. The pipe connector according to claim 7, wherein the outer hub/flange (11, 13) is interference fit or mechanically attached to the outside of the inner hub (10, 12).

9. The pipe connector according to claim 8, wherein the clamp (5) have non-spherical contact surfaces with the connector hub A and thrust ring (6), such that the clamp adjusts to the misalignment of the hubs during connector make-up, and produces a uniform load distribution around hub A and thrust ring (6).

10. A pipe connector for connection of pipes having a moderate angular misalignment, comprising:
a first hub (1); and,
a second hub (2) comprising an external thrust ring (6) and a nose (7), the thrust ring comprising a spherical inner surface, said thrust ruing being pressed and locked against first hub (1) by a clamping device (5) during connection, a sealing ring (4) being in contact with an inner surface of first hub characterized in that the seal ring (4) is in contact with an inner spherical surface of the nose (7), said seal ring (4) being wide enough to bridge and seal a gap between the inner surface of the nose (7) and the inner surface of the first hub.

11. The pipe connector according to claim 10, wherein a clearance between the thrust ring and the first hub or the clamping device allows the second hub to rotate about a transverse axis and adjust to pipe displacement after the connection is made up.

12. The pipe connector according to claim 10, wherein the connector is further provided with a back-up seal (8) for the seal ring (4).

13. The pipe connector according to claim 11, wherein the connector is provided with environmental seals (9) to prevent intrusion of external medium into the connector.

14. The pipe connector according to claim 13, wherein the first hub and the second hub each comprise an inner hub (10, 12) weldable to the pipe, and an outer hub/flange (11, 13), and wherein the outer hub/flange (11, 13) is interference fit or mechanically attached to the outside of the inner hub (10, 12).

15. The pipe connector according to claim 10, wherein the parts of the inner surface of the first hub which are in contact with the seal ring comprises a conical surface.

16. A pipe connector comprising:
a first hub;
a sealing ring, wherein seal ring is suitable for dynamic movement;
a second hub, wherein the second hub is characterized by an external thrust ring with spherical inner and outer surfaces, the thrust ring being pressed and locked against the first hub by a clamp during connection, the spherical contact areas on the thrust ring allow the hubs to be connected even if there is an angular misalignment between the hubs;
environmental seals to prevent intrusion of external medium into the connector; and
a clearance between the thrust ring and the first hub or the clamping device allowing the second hub to rotate about a transverse axis and adjust to pipe displacement after the connection is made up.

17. The pipe connector according to claim 16, wherein the connector is further provided with a back-up seal for the seal ring.

18. The pipe connector according to claim 16, wherein the first hub and the second hub each comprise an inner hub weldable to the pipe, and an outer hub/flange, wherein the inner hub and the outer hub/flange comprise different materials.

19. The pipe connector according to claim 18, wherein the outer hub/flange is interference fit or mechanically attached to the outside of the inner hub.

20. The pipe connector according to claim 16, wherein the parts of the inner surface of the first hub which are in contact with the seal ring comprises a conical surface.
